(19) United States
(12) Patent Application Publication
(10) Pub. No.: US 2026/0275543 A1
(43) Pub. Date: Sep. 17, 2026

(54) POROUS TRANSPORT LAYER

(71) Applicant: NV BEKAERT SA, Zwevegem (BE)

(72) Inventors: Thomas FAVET, Zwevegem (BE); Kris SYNHAEVE, Kuurne (BE); Dieter HELLERT, Zwevegem (BE); Alain SIMONART, Vichte (BE)

(21) Appl. No.: 19/469,140

(22) PCT Filed: Mar. 29, 2024
(86) PCT No.: PCT/EP2024/058756

§ 371 Date: Sep. 25, 2025

(30) Foreign Application Priority Data
Mar. 31, 2023 (EP) 23165857.6

(51) Int. Cl. C25B 11/032; C25B 9/19; C25B 9/75; C25B 9/77; C25B 11/036; C25B 11/042; D04H 1/4234; D04H 1/4374; D04H 1/559; H01M 8/0232; H01M 8/0245

(52) U.S. Cl. CPC C25B 11/032; C25B 9/19; C25B 9/75; C25B 9/77; C25B 11/036; C25B 11/042; D04H 1/4234; D04H 1/4374; D04H 1/559; H01M 8/0232; H01M 8/0245; D10B 2505/00

(57) ABSTRACT

A porous transport layer for an electrolyser or for a fuel cell, comprising —a first nonwoven layer of metal fibers provided for contacting a proton exchange membrane, wherein the first nonwoven layer of metal fibers comprises metal fibers of a first equivalent diameter, wherein the first nonwoven layer of metal fibers has a first surface roughness and a first porosity, —a second nonwoven layer of metal fibers, wherein the second nonwoven layer of metal fibers comprises metal fibers of a second equivalent diameter, wherein the second nonwoven layer of metal fibers has a second surface roughness and a second porosity, wherein the first surface has a material ratio of less than 5% of material at a height of 5 μm, and more than 70% of material at a depth of −5 μm, the first equivalent diameter is smaller than the second equivalent diameter.

### TECHNICAL FIELD

The invention relates to the field of porous transport layers as are e.g., used in electrolysers and fuel cells.

### BACKGROUND ART

Proton exchange membrane (PEM) electrolysers may be used to convert water into separate hydrogen and oxygen streams. Such PEM electrolysers include a polymer electrolyte located between an anode electrode and a cathode electrode. Anode side porous transport layer and cathode side gas diffusion layer are located adjacent to the respective anode and cathode electrodes. A porous metallic, e.g., titanium or titanium alloy, may be used as the anode side porous transport layer.

WO03/059556A2 discloses a stack for use as porous transport layer in a fuel cell or in an electrolyser. The stack comprises an impermeable metal structure, a first metal fiber layer and a second metal fiber layer. The impermeable metal structure is sintered to one side of the first metal fibers layer and the second metal fibers layer is sintered to the other side of the first metal fibers layer. The second metal fiber layer is provided as contact layer to a PEM in a fuel cell or in an electrolyser. The planar air permeability of the stack is more than 0.02 l/min*cm.

A further modified porous transport layer is published in WO2018/189005. The porous transport layer comprises a first nonwoven layer of metal fibers provided for contacting a proton exchange membrane, a second nonwoven layer of metal fibers, and a third porous metal layer. The first nonwoven layer comprises metal fibers of a first equivalent diameter. The second nonwoven layer comprises metal fibers of a second equivalent diameter. The second equivalent diameter is larger than the first equivalent diameter. The third porous metal layer comprises open pores. The open pores of the third porous metal layer are larger than the open pores of the second nonwoven layer of metal fibers. The second nonwoven layer is provided in between and contacting the first nonwoven layer and the third porous metal layer. The second nonwoven layer is metallurgically bonded to the first nonwoven layer and to the third porous metal layer.

The efficiency of a fuel cell system or an electrolyser system is highly affected by the properties of the porous transport layers. WO2020/151997 discloses a porous transport layer based on multiple micro and nano sintered porous layers. The sintered porous layers have a permeability for gaseous and liquid substances in an electrochemical cell, and the multilayer porous transport layer is suited to be assembled between a bipolar plate and a catalyst layer of the electrochemical cell. The multiple micro and nano sintered porous layers are made from irregularly shaped particles of a conductive material. The micro sintered porous layer is made by particles having bigger diameter than the particles in the nano sintered porous layer. The multiple layer structure is achieved by coaxial pressing of multiple irregularly spatted powders where mean particle diameter decreases from layer to layer. The mechanical integrity and specific bulk properties of the porous transport layers are obtained by sintering process.

Another modified porous transport layer is a single layer titanium sheet as disclosed in US2022/0023946. The porous titanium layer that is used as an anode side porous transport layer is formed by a powder process, e.g. tape casting, or by a powder metallurgical technique, in which a titanium powder is pressed into a porous titanium sheet using compaction process. The casted or compacted sheet is then sintered to yield a porous transport layer with an established metallurgical bond. The porous titanium sheet may have a porosity between 40 and 60 percent.

### DISCLOSURE OF INVENTION

The first aspect of the invention is a porous transport layer for an electrolyser or for a fuel cell, comprising
a first nonwoven layer of metal fibers provided for contacting a proton exchange membrane, wherein the first nonwoven layer of metal fibers comprises metal fibers of a first equivalent diameter, wherein the first nonwoven layer of metal fibers has a first surface roughness and a first porosity,
a second nonwoven layer of metal fibers, wherein the second nonwoven layer of metal fibers comprises metal fibers of a second equivalent diameter, wherein the second nonwoven layer of metal fibers has a second surface roughness and a second porosity,
wherein a material ratio of first surface is less than 5% of material at a height of 5 μm, and more than 70% of material at a depth of −5 μm, and preferably more than 75% of material at a depth of −5 μm, wherein the zero level is the mean line of the profile resulting from the subtraction of the best file line through the measurement from a surface roughness measurement, the first equivalent diameter is smaller than the second equivalent diameter, the first porosity is smaller than the second porosity for at least 10%, e.g., in a range of 10% to 50%, and
wherein the first nonwoven layer is metallurgically bonded to the second nonwoven layer.

The first nonwoven layer is provided to act as contact layer to anode electrode side. It is beneficial that the first porosity is smaller than the second porosity for at least 10%. The higher porosity side, i.e., second nonwoven layer of metal fibers of the porous transport layer is to be oriented towards the flow plate side of an electrolyser or a fuel cell. Thus, the high porosity permits more water to enter the pores. While the lower porosity side of i.e., first nonwoven layer of metal fibers of the porous transport layer is to be oriented towards anode electrode side of an electrolyser or a fuel cell. Thus, the low porosity provides an improved electrical contact with the anode electrode. According to the present invention, the porous transport layer comprises two layers having different porosity. Importantly, the first nonwoven layer is metallurgically bonded to the second nonwoven layer. Therefore, the porous transport layer made from the first nonwoven layer and the second nonwoven layer behaves like an assembly. Thus, the porosity at each side and overall porosity of the porous transport layer can be well controlled by an assembly of two separate layers. This is beneficial compared with the single layer porous transport layer as in US2022/0023946, where the first major side of the porous titanium sheet has a porosity which is at least 10 percent higher than the second major opposite second side. This is also beneficial compared with WO2018/189005 and WO2020/151997, where disclose a porous transport layer based on multiple sintered porous layers, because the porosity of each layer in those multiple sintered porous layers are rather similar resulting from a single sintering process.

In addition, the first surface roughness is smaller than the second surface roughness for at least 20%, e.g., in a range of 20% to 120%. The first and second surface roughness are average surface roughness (Ra) and measured according to standard ASME B46.1. PEM electrolysers typically have a catalyst coated membrane. The catalysts coated on the membrane are Platinum (Pt) at the cathode side and Iridium (Ir) at the anode side. The scarcity of Ir is very concerning for the development of PEM. Global Ir production rate is about 7 ton/year. At current catalyst loadings (2 mg/cm²), the annual installation of PEM electrolysers would be limited to 2 GW. Unfortunately, there are no alternative catalyst for the oxygen evolution reaction (anode side) that can compete with Ir, due to its high stability and efficiency. Without any competitive alternative, research is focused on reducing Ir catalyst loading significantly while keeping the same performance. To maintain acceptable performances, the catalyst needs to be in close contact with the porous transport layer (electron path) and the ionomer (hydrogen ion path). With low loading of Ir, implying a thinner layer of catalyst, the contact with the porous transport layer will be reduced. In addition, Ir particles tend to agglomerate, which should also negatively affect the contact with the porous transport layer, and therefore lead to poor performances due to a bad catalyst utilization.

In addition to reducing the catalyst loading, the trend in PEM electrolyser is to decrease the thickness of the membrane, to reduce the overpotential and enhance the overall performances. This trend brings some challenges regarding the mechanical properties at the interface of porous transport layer/anode/membrane. Indeed, the membrane is a fragile component of the PEM cell, and a bad contact with the porous transport layer/anode could lead to the puncture of the membrane, with a strong risk of short circuit within the cell.

According to the invention, a material ratio of first surface is characterized. The Material Ratio (MR) is that ratio of material in the profile to a perfectly flat and smooth profile, at a given height above the mean plane, or in the other word, the ratio of the intersecting area of a plane (i.e., parallel to the mean plane) passing through the surface at a given height to the cross-sectional area of the evaluation region. The Material Ratio Curve (MRC) (aka Bearing Area Curve or Abbot Firestone Curve) is established by evaluating MR at various levels from the highest peak to the lowest valley. For each profile, it is generated by simulating a horizontal line moving through the profile from the top down, evaluating the percentage of contact the line would make with the surface at each level. The MR and MRC are referred and explained in standard ISO_21920-2_EN.

To bring a solution to the above issues, the invention porous transport layer having a material ratio of first surface less than 5% of material at a height of 5 μm, i.e. 5 μm above reference zero level or the mean plane, can be used to enhance the contact with the Ir particles and prevent the puncture of the membrane. In addition, a material ratio of first surface is more than 70% of material at a depth of −5 μm (minus 5 μm), i.e. 5 μm below reference zero level, and preferably more than 75% of material at a depth of −5 μm, wherein the zero level is the mean line of the profile resulting from the subtraction of the best file line through the measurement from a surface roughness measurement. The microstructure of this first nonwoven layer should be finer and denser than the second nonwoven layer, with a small inter-particle distance, to ensure a close contact with the catalyst layer. This also provides a more homogeneous repartition of the forces applied to the membrane and prevent its mechanical degradation. The first surface roughness of the first layer is smaller than the second surface roughness of the second layer for at least 20%, e.g., in a range of 20% to 120%.

The second nonwoven layer is metallurgically bonded to the first nonwoven layer. Metallurgical bonding can e.g., be performed by means of sintering or by means of welding (e.g., by means of capacitive discharge welding, CDW). Preferably, the metal fibers in the first nonwoven layer are metallurgically bonded to each other. Preferably, the metal fibers in the second nonwoven layer are metallurgically bonded to each other.

Although the presence of the first nonwoven layer of metal fibers negatively affects the inflow and outflow of molecules through the plane, and consequently negatively affects the functionality of the electrolyser or fuel cell as the reduced flow increase the required overvoltage of the electrolyser. The metallurgical bonds between the layers are important, as such bonds provide for a low electrical resistance between the layers. Providing a reliable metallurgical bonding between the first nonwoven layer and the second nonwoven layer is desirable. The benefit is a reduced ohmic resistance of the porous transport layer, reducing the overvoltage of the electrolyser, and an improved mechanical stability of the porous transport layer. There is inevitably a certain amount of hairiness on the surface of both nonwovens. Consequently, fibers from the first nonwoven will penetrate to a certain extent in the second nonwoven, and metal fibers of the second nonwoven will penetrate to a certain extent in the first nonwoven. The penetrations create enhanced metallic contacts and metallurgical bonding, both beneficial for the reduced ohmic resistance of the porous transport layer, reducing the overvoltage of the electrolyser, and an improved mechanical stability of the porous transport layer.

With equivalent diameter of a fiber is meant the diameter of a circle having the same surface area as the cross section of a fiber which does not necessarily has a circular cross section.

The pore size of the nonwoven layers can be observed in several ways. A cross section through the thickness of the porous transport layer can be made, and the cross section can be analysed under a microscope, in which the pores—and their sizes—become visible. A more advanced method is X-ray tomography of the porous transport layer. Alternatively, the pore size can be measured by mercury porosimetry.

According to the present invention, the first equivalent diameter can be less than 20 μm and preferably less than 15 μm. The use of the fine fibers is beneficial, as a large contact area with the PEM is provided for the electrochemical reaction to take place; and the fine pores—present because of the use of the fine fibers in the first nonwoven layer—allow capillarity for efficient mass transport to and from the reaction sites at the PEM. The second equivalent diameter is preferably less than 50 μm, and more preferably less than 30 μm. The second equivalent diameter is preferably bigger than the first equivalent diameter. As an example, the first equivalent diameter is 14 μm and the second equivalent diameter is 22 μm. The second nonwoven layer of metal fibers has bigger diameter and thus the pores in the second nonwoven layer is bigger than the pores in the first nonwoven layer. As an example, the first nonwoven layer has a porosity in a range of 35 to 50%, preferably in a range of 40 to 50%, the second nonwoven layer has a porosity in a range of 51 to 90% and the overall porosity of the porous transport layer is in a range of 50 to 80%. The positive consequence is an efficient planar mass inflow and outflow. Preferably, the thickness of the first nonwoven layer is less than 100 μm. Such embodiments provide a particularly beneficial porous transport layer, as the first nonwoven layer that provides the contact layer with the PEM is thin, such that in the available space for the provision of the porous transport layer in the electrolyser, a larger thickness of the second nonwoven layer can be provided; the second nonwoven layer that provides for the in-plane inflow and outflow of water and reaction products.

Preferably, the thickness of the second nonwoven layer is at least double the thickness of the first nonwoven layer. The planar flow is thus further improved thanks to the thickness of the second nonwoven layer, thereby providing a large cross section for planar mass flow. The second layer has a higher porosity, and it has positive impact on the planar permeability since mass limitations are under control. The higher porosity of the second layer permits more water to enter the pores, while the lower porosity of the first layer on the anode side provide an improved electrical contact with the anode. Moreover, this structure has cost advantages since the application of coarse fibers in the second layer with higher sintered porosity maintains low cost of the transport layer.

Preferably, the first nonwoven layer and the second nonwoven layer comprise—and more preferably consist out of—titanium fibers. Alternatively, the first and second nonwoven layer can be made from titanium alloy fibers, nickel fibers, nickel alloy fibers or stainless-steel fibers.

In a preferred embodiment, the metal fibers of the first nonwoven layer and/or of the second nonwoven layer have a discrete length; and have a cross section, wherein the cross section has two neighboring straight lined sides with an included angle of less than 90 degrees and one or more irregularly shaped curved sides. The metal fibers of the first nonwoven layer have a large surface area thanks to the irregular shape of their cross section. The consequence is a large surface area in contact with the proton exchange membrane on which the electrochemical reaction can take place, especially when the surface of the first nonwoven layer is coated with catalyst or when the proton exchange membrane is coated with catalyst. Such fibers can be made as described in WO2014/048738A1. Another technology for producing such fibers is described in U.S. Pat. No. 4,640,156.

Alternatively, the metal fibers of the second nonwoven layer have a quadrangular, and preferably a rectangular cross section. A technology for manufacturing such fibers is disclosed in U.S. Pat. No. 4,930,199. This provides a benefit: the metal fibers of the second nonwoven layer have a more compact cross section, which does not create obstructions for the planar inflow and outflow of gases in the electrolyser or fuel cell in which the porous transport layer is used.

As an example, the second nonwoven layer may further comprise one or more expanded metal sheets or woven wire meshes; wherein the expanded metal sheets or woven wire meshes are metallurgically bonded to each other, e.g., by means of sintering or by means of welding, e.g., capacitive discharge welding (CDW). It is a benefit that expanded metal sheets have a higher stiffness than sintered nonwovens. The porous transport layer of the invention may further comprise a third porous metal layer having bigger pore size and/or porosity adjacent to the second nonwoven layer of metal fibers. A multilayer porous transport layer including one or more expanded metal sheets allows a high surface area at the PEM side, while the stiffness prevents sagging when compressed against a profiled surface provided by a bipolar plate in which flow channels have been machined.

A second aspect of the invention is a method of making a porous transport layer for an electrolyser or for a fuel cell as in any of the preceding claims, comprising the steps of, preferably in the order of:
(a) making a first nonwoven non-sintered layer of metal fibers,
(b) compressing the first nonwoven non-sintered layer of metal fibers to have a compressed first nonwoven layer of metal fibers,
(c) making a second nonwoven non-sintered layer of metal fibers,
(d) stacking the compressed first nonwoven non-sintered layer of metal fibers with the second nonwoven non-sintered layer of metal fibers to form a dual layer structure,
(e) sintering the dual layer structure, e.g., in an oxygen-free or low oxygen atmosphere at 1000 to 1200 degrees Celsius for 1 to 2 hours, preferably under a load of 70 kg/m² to 200 kg/m², and
(f) optionally compressing the sintered dual layer structure to a determined thickness.

In order to have a durable compressed nonwoven layer, the compression can be applied under a load force of 30 to 80 kN/mm², e.g., 60 kN/mm². Such applied forces can result in a nonwoven layer having a porosity of 30% to 50%. The applied force is selected depending on a desired porosity. This applied force according to the present invention is significantly bigger than the normal force applied for calendaring of fiber web. The fibers are better entangled in the nonwoven layer after the compression.

The inventive porous transport layer according to the present invention is made by one sintering process. In comparison with a dual-layer porous transport layer that is made by two sintering steps, the inventive porous transport layer is less expensive since one sintering step is skipped. Surprisingly, the inventive porous transport layer presents a smoother surface and better performance than a similar dual-layer porous transport layer made by two sintering steps.

A third aspect of the invention is a stack for an electrolyser or a fuel cell, comprising a porous transport layer as in the first aspect of the invention and a bipolar plate. The bipolar plate contacts the second nonwoven layer. Preferably, the bipolar plate is metallurgically bonded to the second nonwoven layer, e.g., by means of sintering or welding. Preferably, the bipolar plate is flat over its entire surface that is contacting the second nonwoven layer meaning that no flow fields are provided in the bipolar plate.

A fourth aspect of the invention is an assembly of a porous transport layer as in the first aspect of the invention and a proton exchange membrane. The first nonwoven layer contacts the proton exchange membrane. Preferably a catalyst is provided on the first nonwoven layer at the side where the first nonwoven layer contacts the proton exchange membrane, or a catalyst is provided on the proton exchange membrane at the side in contact with the first nonwoven layer.

A fifth aspect of the invention is an assembly of a stack as in the third aspect of the invention and a proton exchange membrane. The first nonwoven layer contacts the proton exchange membrane. Preferably a catalyst is provided on the first nonwoven layer at the side where the first nonwoven layer contacts the proton exchange membrane, or a catalyst is provided on the proton exchange membrane at the side in contact with the first nonwoven layer.

### BRIEF DESCRIPTION OF THE FIGURES

FIG. 1 shows schematically a cross-section of a porous transport layer according to the invention.

FIG. 2 compares material ratio curve of a porous transport layer according to the invention (I) with several reference porous transport layers (a,b,c,d,e).

FIG. 3 compares the variation of the porosity (P) through the thickness (d) of the invention porous transport layer (I) with the reference porous transport layer (R).

FIG. 4 illustrates and compares voltage at measured cell current density (IV curve) of Proton Exchange Membrane Water Electrolysis (PEMWE) cell applying the invention porous transport layer (I) with reference porous transport layer (d) and (e).

### MODE(S) FOR CARRYING OUT THE INVENTION

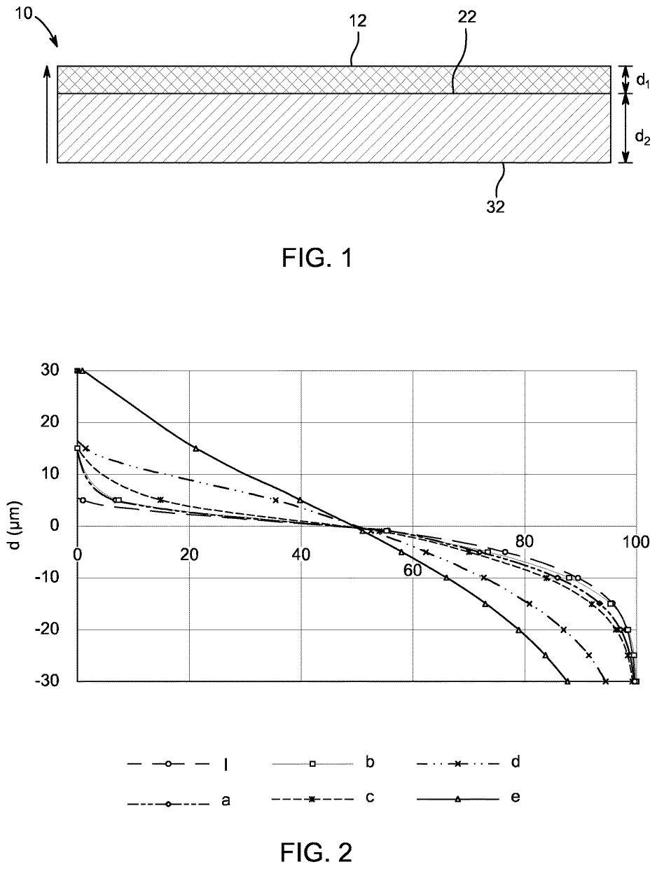

An exemplary porous transport layer 10 according to the invention is schematically shown in FIG. 1. The exemplary porous transport layer 10 consists of a first nonwoven layer 12 of titanium fibers and a second nonwoven layer 22 of titanium fibers. The first nonwoven layer of titanium fibers is provided for contacting a proton exchange membrane in an electrolyser. The first nonwoven layer of titanium fibers comprises and preferably consists of titanium fibers with an equivalent diameter of 14 μm. The titanium fibers of the first nonwoven layer have 10 mm length; and have a cross section, wherein the cross section has two neighbouring straight-lined sides with an included angle of less than 90 degrees and one or more irregularly shaped curved sides. The first nonwoven layer 12 has a thickness d₁ about 40 μm. The first nonwoven layer 12 has a porosity of about 43%.

The second nonwoven layer 22 comprises and preferably consists of 400 g/m² of titanium fibers with an equivalent diameter of 22 μm. The thickness d₂ of the second nonwoven layer 22 is about 160 μm to 200 μm. The second nonwoven layer 22 has a porosity of about 58%. Thus, the overall porosity of the porous transport layer consisting of the first and second nonwoven layers has a porosity of about 56%. Because of the larger equivalent diameter of fibers in the second nonwoven layer 22 compared to the first nonwoven layer 12, the open pores are larger in the second nonwoven layer 22 than in the first nonwoven layer 12. The surface roughness of the first nonwoven layer 12 is smaller than the surface roughness of the second nonwoven layer 32 for at least 20%. As shown in FIG. 2 of Material ratios (in %) at different given depth (from −30 μm to +30 μm) of the inventive porous transport layer (I), the first surface has a material ratio of less than 5% of material at a height of 5 μm, and more than 70% of material at a depth of −5 μm.

Such a porous transport layer 10 is made according to the steps of, preferably in order:
(a) making a first nonwoven layer of titanium fibers,
(b) compressing the first nonwoven layer of metal fibers to have a compressed first nonwoven layer of metal fibers, preferably under a load force of 30 to 80 kN/mm², e.g. 60 kN/mm²,
(c) making a second nonwoven layer of metal fibers.
(d) stacking the compressed sintered first nonwoven layer of titanium fibers with the second nonwoven layer of titanium fibers to form a dual layer structure,
(e) sintering the dual layer structure, e.g., in an oxygen-free or low oxygen atmosphere at 1000 to 1200 degrees Celsius for 1 to 2 hours, preferably under a load of 70 kg/m² to 200 kg/m²,
(f) optionally compressing the sintered dual layer structure to a determined thickness.

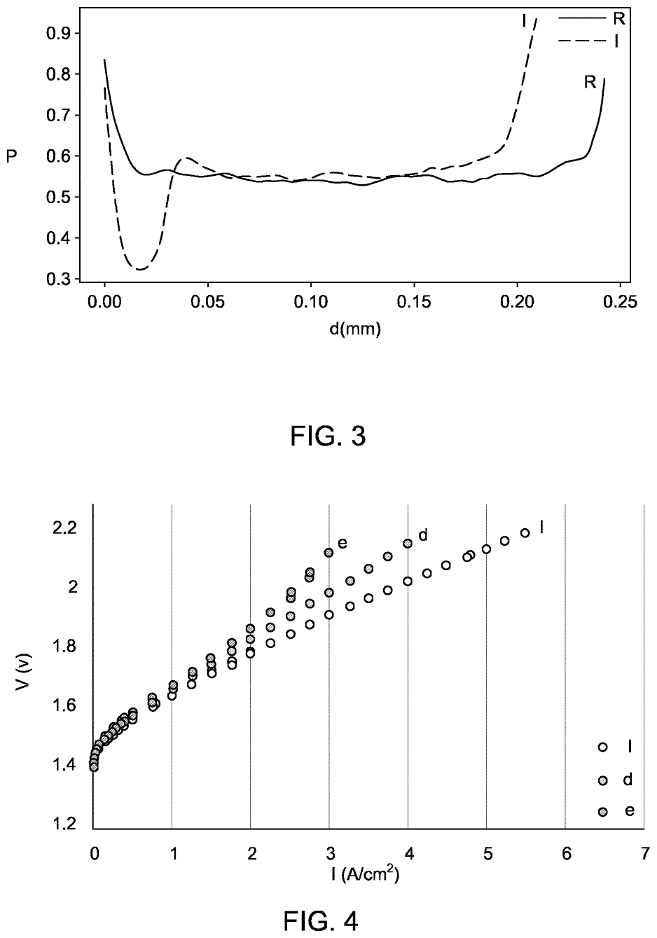

A similar dual layer porous transport layer (R) was made as a reference for comparastion according to the above steps except discarding step (b). Thus, for the comparable dual layer porous transport layer (R), the fiber diameter in the first layer is smaller than the fiber diameter of the second layer, e.g. the first layer here consists of titanium fibers with an equivalent diameter of 14 μm while the second layer consists of titanium fibers with an equivalent diameter of 22 μm. Without the pre-compression step (b) during the production of the reference porous transport layer (R), the first nonwoven layer of titanium fibers was stacked with the second nonwoven layer of titanium fibers to form a dual layer structure, which was then sintered at comparable conditions. The variation of the porosity through the thickness of the invention porous transport layer (I) and the reference porous transport layer (R) are compared in FIG. 3. As shown in FIG. 3, the invention porous transport layer (I) has a dual porosity as described above, while the reference porous transport layer (R) has a uniform porosity through the thickness of the overall porous transport layer. The porosity of the reference transport layer (R) is about 56% for both the first and second nonwoven layers, which is similar to the porosity of the second nonwoven layer of the invention porous transport layer (I). The pre-compressing step (b) before sintering has brought significant advantage with respect to creating a dual layer structure having different porosities. The formed dual layer porous transport layer according to the invention has a top surface with lower porosity and roughness and a back layer with higher porosity, which is desirable for its application.

The exemplary porous transport layer (I) according to the invention has been compared with several reference porous transport layers: (a) a comparable dual-layer porous transport layer having similar structure of inventive porous transport layer but made by different process; (b) a porous transport layer having a porosity of 40% made by titanium powder; (c) a porous transport layer having a porosity of 56% made by titanium fibers with an equivalent diameter of 14 μm; (d) a porous transport layer having a porosity of 56% made by titanium fibers with an equivalent diameter of 22 μm; (e) a porous transport layer having a porosity of 77% made by titanium fibers with an equivalent diameter of 22 μm.

Reference porous transport layer (a) having dual layers are made by the process in orders as below:
(a) making a first nonwoven layer of titanium fibers,
(b) sintering the first nonwoven layer of titanium fibers to have a sintered first nonwoven layer of titanium fibers, e.g., in an oxygen-free or low oxygen atmosphere at 1000 to 1200 degrees Celsius for 1 to 2 hours, preferably under load of 70 kg/m² to 200 kg/m²,
(c) compressing the sintered first nonwoven layer of titanium fibers to have a compressed sintered first nonwoven layer of titanium fibers,
(d) making a second nonwoven layer of titanium fibers,
(e) stacking the compressed sintered first nonwoven layer of titanium fibers with the second nonwoven layer of titanium fibers to form a dual layer structure,
(f) sintering the dual layer structure, e.g., in an oxygen-free or low oxygen atmosphere at 1000 to 1200 degree Celsius for 1 to 2 hours, preferably under load of 70 kg/m² to 200 kg/m², and
(g) optionally compressing the sintered dual layer structure to a determined thickness.

The roughness of the above inventive porous transport layer and reference porous transport layers were measured. The first surface of the inventive porous transport layer, i.e., the surface of the first layer made from 14 μm titanium fibers was measured. For reference porous transport layer (a), it is also measured on the surface made from 14 μm titanium fibers. Material ratios at given depths were calculated using the roughness measurement data and OmniSurf software in line with standard ISO_21920-2_EN. The mean line of the profile is the zero level/line resulting from the subtraction of the best file line through the measurement from the surface roughness measurement. FIG. 2 compares Material Ratio Curve of the porous transport layer according to the invention with that of several reference porous transport layers, giving the ratio of material in the profile by horizontal axis or X-axis (in %) at given depth by vertical axis or Y-axis (in μm). The distribution of material ratios of the inventive porous transport layer (I) and reference porous transport layers (a,b,c,d,e) at given depth level is summarized in table 1.

TABLE 1
Material ratios (in %) at different given depth (from −30
μm to +30 μm) of the inventive porous transport layer
(l) and reference porous transport layers (a, b, c, d, e).

| | Depth d (μm) | | | | | | | | | |
|---|---|---|---|---|---|---|---|---|---|---|
| | +30 | +15 | +5 | −1 | −5 | −10 | −15 | −20 | −25 | −30 |
| l | 0.00 | 0.00 | 1.00 | 55.61 | 76.56 | 89.56 | 95.75 | 98.26 | 99.33 | 99.74 |
| a | 0.00 | 0.00 | 6.84 | 54.93 | 71.96 | 85.88 | 93.38 | 97.20 | 98.84 | 99.52 |
| b | 0.00 | 0.00 | 7.48 | 55.46 | 73.48 | 88.00 | 95.33 | 98.57 | 99.60 | 99.91 |
| c | 0.00 | 0.04 | 14.94 | 54.10 | 70.09 | 83.83 | 91.95 | 96.27 | 98.45 | 99.39 |
| d | 0.00 | 1.61 | 35.52 | 52.54 | 62.39 | 72.70 | 80.89 | 87.02 | 91.48 | 94.52 |
| e | 0.98 | 21.24 | 39.90 | 51.04 | 58.04 | 66.05 | 73.01 | 78.94 | 83.75 | 87.66 |

As shown in FIG. 2, the highest peak of Material Ratio Curve of the inventive porous transport layer (I) is the lowest, which is about 6 μm. Table 1 shows the material ratio of the inventive porous transport layer (I) is 1.00% at a given depth of 5 μm, which was significantly smaller than the rest of reference porous transport layers. In addition, the material ratio of the inventive porous transport layer is more than 75% at a depth of −5 μm. The zero level is the mean line of the profile resulting from the subtraction of the best file line through the measurement from a surface roughness measurement. The reference porous transport layers (a,c) made from titanium fibers with 14 μm equivalent diameter also have smaller material ratio peak compared with reference porous transport layers (d,e) made from titanium fibers with 22 μm equivalent diameter—this proved that material ratio peak decrease with finer fiber diameter. On the other hand, the material ratio peak of reference porous transport layer (d) was smaller than that of reference porous transport layer (e) made by same fiber but having different (higher) porosity; and the material ratio peak of reference porous transport layer (a) was smaller than that of reference porous transport layer (c) made by same fiber but having different (higher) porosity—this proved that that material ratio peak decrease with lower porosity. In addition, the core roughness and the valley of the inventive porous transport layer (I) and reference porous transport layers (a, b) are rather comparable. The valley of Material Ratio Curve of the inventive porous transport layer (I) is much higher than those of reference porous transport layers (d,e).

Surprisingly, although reference porous transport layer (a) is made from dual-layer porous transport layers having similar structure of the inventive porous transport layer, the material ratio at peak of the inventive porous transport layer is small than that of reference porous transport layer (a). At a given depth of of 5 μm, the material ratio of the inventive porous transport layer (I) is 1.00%, while the material ratio of reference porous transport layer (a) is 6.84%. At a given depth of −5 μm, the material ratio of the inventive porous transport layer (I) is 76.56%, while the material ratio of reference porous transport layer (a) is 71.96%. Overall, the inventive porous transport layer presents best desired properties: a low material ratio value at peak region and high material ratio value at valley region. This would provide better support to the proton exchange membrane of electrolysers and fuel cells. Thus, stretching of membrane and a chance to rupture is decreased by using the inventive porous transport layer. This also guarantees a better contact with the catalysts and better reaction at the anode. Moreover, it is noted that inventive porous transport layer is made by one sintering step while the reference porous transport layer (a) is made by two sintering steps, which are more expensive. The low cost is another advantage of the inventive porous transport layer.

On the other hand, the porous transport layer shall have a required permeability. The permeability of the inventive porous transport layer (I) and reference porous transport layers (a,b,c,d,e) are evaluated by standardized methods and shown in table 2.

As shown in table 2, the permeability of the inventive porous transport layer is 150 l/dm²/min. This meets the requirements as a high-quality porous transport layer for the planar inflow and outflow of gases in the electrolyser or fuel cell in which the porous transport layer is used. The permeability of the reference powder porous transport layer (type b: 26 l/dm²/min in table 2) is rather small and is not desirable. In this respect, fiber-based porous transport layer is more advanced due to its high permeability compared with power-based porous transport layer.

TABLE 2
Permeability test results of the inventive porous transport layer
(l) and reference porous transport layers (a, b, c, d, e).

| Type of porous | Permeability |
|---|---|
| transport layer | l/dm²/min @200 Pa |
| l | 150 |
| a | NA |
| b | 26 |
| c | 124 |
| d | 194 |
| e | 1290 |

The invention porous transport layer (I) and reference porous transport layer (d) and (e) were in-situ tested in a Proton Exchange Membrane Water Electrolysis (PEMWE) cell. The cell voltage (in Volt) at given measured cell current density (in A/cm²) (IV curve) are illustrated and compared in FIG. 4. It is noted the cell voltage resulting from the invention porous transport layer (I) is lower compared with the cell voltage resulting from the reference porous transport layer at the same cell current density. There is 120 mV difference between the invention porous transport layer (I) and reference porous transport layer (d) at 4 A/cm² current density. The IV curve shows a lower cell voltage at a given current density obtained with the invention porous transport layer (I) and thus indicates a better performance of the invention porous transport layer (I). In addition, thanks to the low porosity and surface roughness of the invention porous transport layer (I), the anode catalyst loading can be in a range of 0.7-0.8 mgIrOx/cm², which is lower than that in the state of the art. This is an additional advantage of a PEMWE cell applying the invention porous transport layer (I) with a reduced loading of the expensive Iridium catalyst.

1. A porous transport layer for an electrolyser or for a fuel cell, comprising
a first nonwoven layer of metal fibers provided for contacting a proton exchange membrane, wherein the first nonwoven layer of metal fibers comprises metal fibers of a first equivalent diameter,
wherein the first nonwoven layer of metal fibers has a first surface roughness and a first porosity,
a second nonwoven layer of metal fibers, wherein the second nonwoven layer of metal fibers comprises metal fibers of a second equivalent diameter, wherein the second nonwoven layer of metal fibers has a second surface roughness and a second porosity,
wherein the first surface has a material ratio of less than 5% of material at a height of 5 μm, and more than 70% of material at a depth of −5 μm,
the first equivalent diameter is smaller than the second equivalent diameter, the first surface roughness is smaller than the second surface roughness for at least 20%, e.g., in a range of 20% to 120%,
the first porosity is smaller than the second porosity for at least 10%, e.g., in a range of 10% to 50%, and
wherein the first nonwoven layer is metallurgically bonded to the second nonwoven layer.

2. The porous transport layer as in claim 1, wherein the thickness of the second nonwoven layer is at least double the thickness of the first nonwoven layer.

3. The porous transport layer as in claim 1, wherein the first equivalent diameter is less than 20 μm.

4. The porous transport layer of claim 1, wherein the second equivalent diameter is bigger than the first equivalent diameter, and less than 50 μm, preferably less than 30 μm.

5. The porous transport layer of claim 1, wherein the first equivalent diameter is 14 μm and the second equivalent diameter is 22 μm.

6. The porous transport layer of claim 1, wherein the thickness of the first nonwoven layer is less than 100 μm.

7. The porous transport layer of claim 1, wherein the first nonwoven layer and the second nonwoven layer comprise, and preferably consist of any one of titanium fibers, nickel fibers, or stainless-steel fibers.

8. The porous transport layer of claim 1, wherein the metal fibers of the first nonwoven layer have a discrete length; and have a cross section, wherein the cross section has two neighbouring straight-lined sides with an included angle of less than 90 degrees and one or more irregularly shaped curved sides.

9. The porous transport layer of claim 1, wherein the first nonwoven layer has porosity in a range of 30 to 50%, the second nonwoven layer has a porosity in a range of 51 to 90% and the overall porosity of the porous transport layer is in a range of 50 to 80%.

10. The porous transport layer of claim 1, wherein said porous transport layer further comprises a third porous metal layer having bigger pore size and/or porosity adjacent to the second nonwoven layer of metal fibers.

11. A method of making a porous transport layer for an electrolyser or for a fuel cell of claim 1, comprising the steps of:
(a) making a first nonwoven non-sintered layer of metal fibers,
(b) compressing the first nonwoven non-sintered layer of metal fibers to have a compressed first nonwoven layer of metal fibers,
(c) making a second nonwoven non-sintered layer of metal fibers,
(d) stacking the compressed first nonwoven non-sintered layer of metal fibers with the second nonwoven non-sintered layer of metal fibers to form a dual layer structure,
(e) sintering the dual layer structure, e.g., in an oxygen-free or low oxygen atmosphere at 1000 to 1200 degrees Celsius for 1 to 2 hours, preferably under load of 70 kg/m2 to 200 kg/m2,
(f) optionally compressing the sintered dual layer structure to a determined thickness.

12. The method of making a porous transport layer as in claim 11, wherein in step (b), the compression is applied under a load force of 30 to 80 kN/mm2.

13. A stack for an electrolyser or a fuel cell, comprising
a porous transport layer of claim 1, and
a bipolar plate,
wherein the bipolar plate contacts the second nonwoven layer, and
preferably wherein the bipolar plate is metallurgically bonded to the second nonwoven layer.

14. An assembly of a porous transport layer of claim 1 and a proton exchange membrane, or assembly of a stack for an electrolyser or a fuel cell and a proton exchange membrane,
wherein the first nonwoven layer contacts the proton exchange membrane, and preferably wherein a catalyst is provided on the first nonwoven layer at the side where the first nonwoven layer contacts the proton exchange membrane.
